(19) United States
(12) Patent Application Publication
(10) Pub. No.: US 2003/0104726 A1
(43) Pub. Date: Jun. 5, 2003

(54) Connector having a shielding shell provided with a locking portion

(75) Inventor: Toshio Masumoto, Tokyo (JP)

Correspondence Address: WILLIAM COLLARD, COLLARD & ROE, P.C., 1077 NORTHERN BOULEVARD, ROSLYN, NY, 11576, US

(73) Assignee: JAPAN AVIATION ELECTRONICS INDUSTRY, LIMITED

(21) Appl. No.: 10/304,507

(22) Filed: Nov. 26, 2002

(30) Foreign Application Priority Data
Nov. 30, 2001 (JP) 367586/2001

(51) Int. Cl. H01R 13/648

(52) U.S. Cl. 439/607

(57) ABSTRACT

A connector (11) has a locking portion (13b) for locking a connected state in which the connector is connected to a mating connector (1). The locking portion is integral with a conductive shielding shell (13) covering an insulator housing (12) holding a conductive contact (14a). The housing has a guide portion (12a) for guiding the mating connector when it is connected. The locking portion is formed at a position corresponding to the guide portion.

### BACKGROUND OF THE INVENTION

This invention relates to a connector and, in particular, to a connector capable of locking a connected state in which the connector is connected to a mating connector.

A connector of the type is disclosed, for example, in Japanese Unexamined Utility Model Publication No. 43486/1993 (JP 5-43486 U). The connector comprises a mold base and a shielding cover covering the mold base. The mold base is formed by an insulator and has a flat portion. The flat portion is provided with an insert portion protruding from its center. The insert portion holds a conductive contact.

The shielding cover comprises a shell having an electromagnetic shielding function for the contact, and a locking member formed as a component separate from the shell and adapted to be engaged with a mating connector. The locking member is put on the shell and, in this state, coupled with the mold base.

In the above-mentioned manner, the connector is assembled. With this structure, the connector is provided with so-called EMI protection and has a locking function assuring strong retention between the connector and the mating connector.

However, the EMI protection and the locking function are achieved by the separate components, i.e., the shell and the locking member. This makes it difficult to avoid an increase in production cost of the connector resulting from an increase in number of components. The production cost includes die cost, material cost, machining cost, assembling cost, and so on.

### SUMMARY OF THE INVENTION

It is therefore an object of the present invention to provide a connector which is provided with EMI protection and has strong retention sufficient to maintain a connected state and which can be produced with a reduced number of components.

Other objects of the present invention will become clear as the description proceeds.

According to an aspect of the present invention, there is provided a connector including first and second connector elements adapted to be connected to and disconnected from each other, the first connector element comprising a first contact, a first housing holding the first contact, a first shielding shell covering the first housing, a first guide portion formed in the first housing, and a first locking portion coupled to the first shielding shell and faced to the first guide portion, the second connector element comprising a second contact, a second housing holding the second contact, a second shielding shell covering the second housing, a second guide portion integral with the second housing and adapted to be guided by the first guide portion, and a second locking portion coupled to the second shielding shell, faced to the second guide portion, and adapted to be locked to the first locking portion.

According to another aspect of the present invention, there is provided a connector having a locking portion for locking a connected state in which said connector is connected to a mating connector, the connector comprising a conductive contact, an insulator housing holding the contact, and a conductive shielding shell covering the housing, the housing having a guide portion for guiding the mating connector when the mating connector is connected, the locking portion being integral with the shielding shell and formed at a position corresponding to the guide portion.

### BRIEF DESCRIPTION OF THE DRAWINGS

FIG. 1 is a perspective view of a connector, including a cable connector and a board connector, according to an embodiment of the present invention in a disconnected state, with the board connector mounted on a board;

FIG. 2 is a perspective view of the connector in FIG. 1 in a connected state, with the cable connector connected to a cable;

FIG. 2A is a sectional view of the connector illustrated in FIG. 2;

FIGS. 3A-3C are views for describing an operation of a locking portion when the connector in FIG. 1 is put into the connected state;

FIG. 4 is a perspective view for describing an operation when the connector in FIG. 2 is put into the disconnected state;

FIG. 4A is a sectional view of the connector when the operation of FIG. 4 is carried out;

FIGS. 5A-5C are plan views of a half of the cable connector, for describing an assembling operation of the cable connector;

FIG. 5D is a sectional view of the cable connector after it is assembled:

FIG. 6A is a plan view of a shielding shell of the cable connector;

FIG. 6B is a rear view of the shielding shell of the cable connector;

FIG. 6C is a bottom view of the shielding shell of the cable connector;

FIG. 6D is a side view of the shielding shell of the cable connector;

FIG. 6E is a sectional view taken along a line VIe-VIe in FIG. 6A;

FIG. 6F is a sectional view taken along a line VIf-VIf in FIG. 6A;

FIG. 7 is a development view of the shielding shell;

FIG. 8 is a plan view of a part of a modification of the cable connector;

FIG. 9 is a perspective view of a part of a connector according to another embodiment of the present invention in a disconnected state; and

FIG. 10 is a side view of a connector according to still another embodiment of the present invention in a connected state.

### DESCRIPTION OF THE PREFERRED EMBODIMENTS

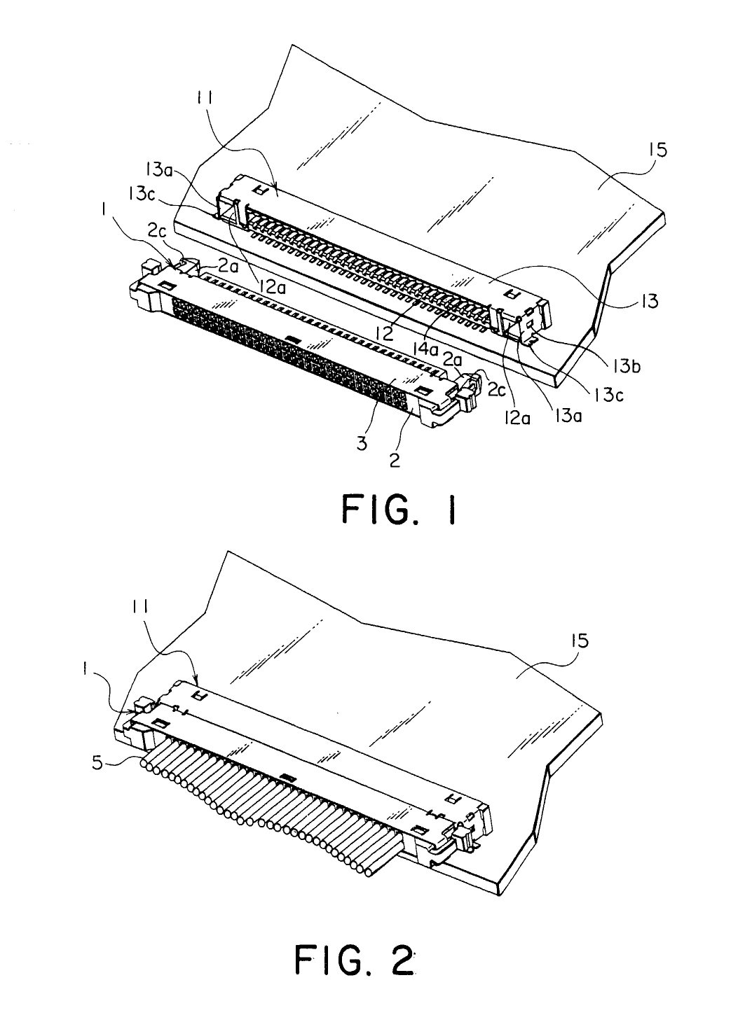

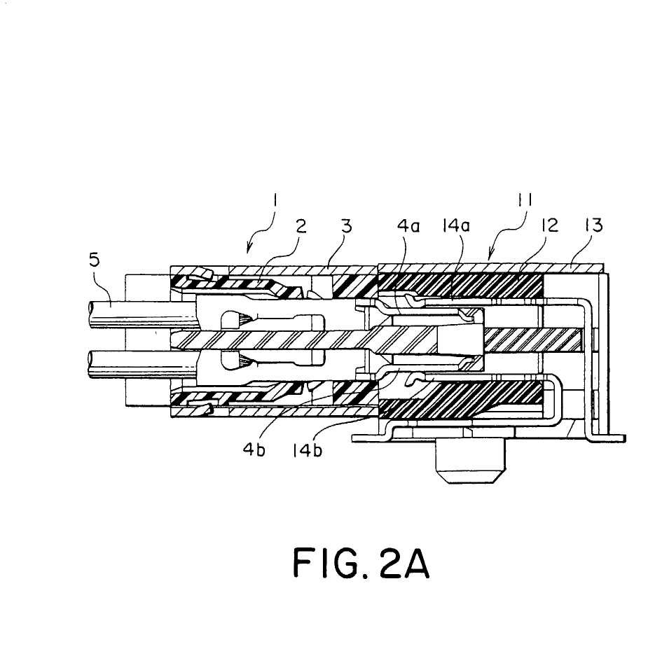

Referring to FIGS. 1, 2, and 2A, description will be made as regards a whole of a connector according to an embodiment of the present invention.

The connector illustrated in the figures is mainly used for an LCD monitor and comprises a cable connector 1 and a board connector 11 to be connected to and disconnected from each other. The board connector 11 is referred to as a first connector element. The cable connector 1 is referred to as a second connector element.

The cable connector 1 comprises an insulator housing 2 having upper and lower housing parts, a conductive shielding shell 3 covering the housing 2, a plurality of conductive contacts 4a and 4b held by the housing 2 and aligned in upper and lower rows. On the other hand, the board connector 11 comprises an insulator housing 12 having upper and lower housing parts, a conductive shielding shell 13 covering the housing 12, and a plurality of conductive contacts 14a and 14b held by the housing 12 and aligned in upper and lower rows.

To the contacts 4a and 4b of the cable connector 1, a plurality of cables 5 are crimped and connected, respectively. The board connector 11 is mounted on a board 15 and the contacts 14a and 14b are connected to an electric circuit (not shown) on the board 15.

The housing 2 has a coupling side for coupling to the board connector 11. A pair of guided portions 2a is integral with the housing 2 and protrudes therefrom at transversal opposite ends on the coupling side of the housing 2. Each of the guided portions 2a has a cut portion 2c. Above the cut portion 2c, a locked arm 3a of the shielding shell 3 is located. The locked arm 3a has an inclined end 3e.

The housing 12 of the board connector 11 is provided with a pair of guiding portions 12a depressed at transversal opposite ends thereof. Each of the guiding portions 12a has an open end closed by a side surface portion 13a of the shielding shell 13. Each side surface portion 13a has a hole 13b and a soldered portion 13c. In the manner which will later be described, the hole 13b serves as a locking portion for locking a connected state in which the board connector 11 is connected to the cable connector 1.

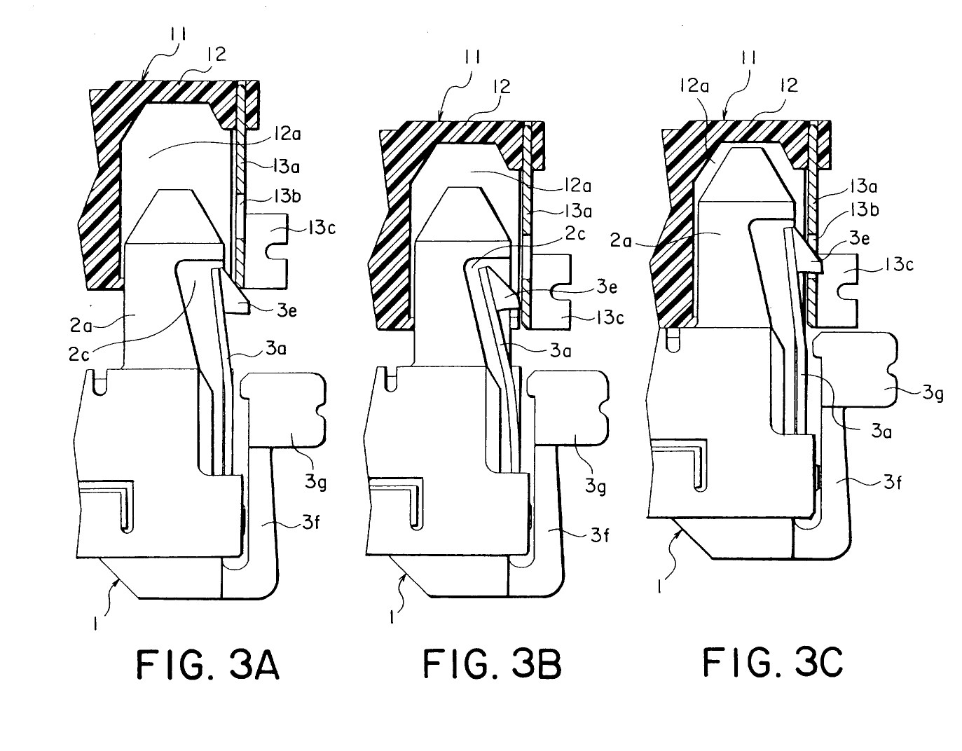

Referring to FIGS. 3A to 3C, the description will be directed to an operation of connecting the cable connector 1 and the board connector 11.

When the cable connector 1 is fitted to the board connector 11, the inclined end 3e of the locked arm 3a is brought into contact with the side surface portion 13a, as illustrated in FIG. 3A. When the cable connector 1 is pushed further, the locked arm 3a is elastically deformed so that the inclined end 3e enters into the cut portion 2c, as illustrated in FIG. 3B. When the guided portion 2a enters further inward into the guiding portion 12a, the locked arm 3a is restored so that the inclined end 3e is inserted into the hole 13b, as illustrated in FIG. 3C. As a consequence, the inclined end 3e of the locked arm 3a is engaged with an edge of the hole 13b of the shielding shell 13. Thus, the cable connector 1 and the board connector 11 are locked to each other in a connected state.

The guided portions 2a of the cable connector 1 are formed at the transversal opposite ends of the housing 2 to be asymmetrical with each other while the guiding portions 12a of the board connector 11 are formed at the transversal opposite ends of the housing 12 to be asymmetrical with each other. With this structure, when the cable connector 1 is fitted to the board connector 11, it is possible to inhibit coupling error such that left and right sides, in other words, upper and lower surfaces are erroneously reversed.

The shielding shell 3 has opposite side surfaces provided with a pair of unlocking arms 3f integral with the housing 2 and adjacent to outer surfaces of the locked arms 3a. Each of the unlocking arms 3f has a finger push portion 3g formed at its end.

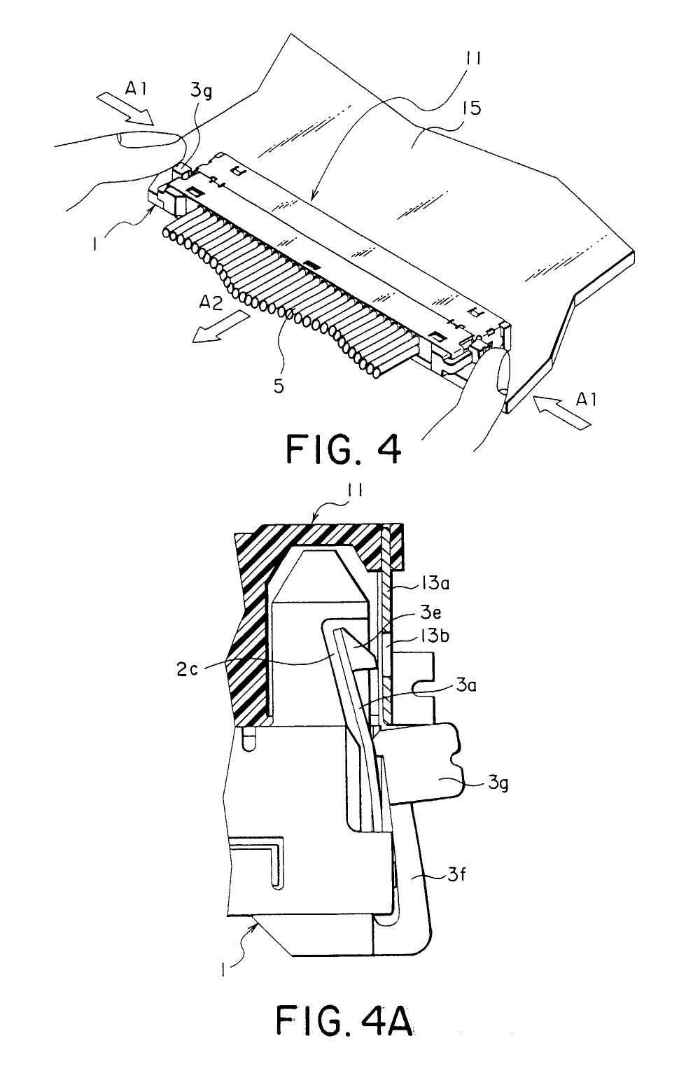

Referring to FIGS. 4 and 4A, the description will be directed to an operation of disconnecting the cable connector 1 and the board connector 11 from each other.

As illustrated in FIG. 4, the finger push portions 3g are pressed by fingers in directions depicted by arrows A1, respectively. Then, as illustrated in FIG. 4A, the inclined ends 3e escape from the holes 13b and enter into the cut portions 2c, respectively. In this state, the cable connector 1 is moved with respect to the board connector 11 in a direction A2 in FIG. 4. As a consequence, the cable connector 1 and the board connector 11 are disconnected from each other.

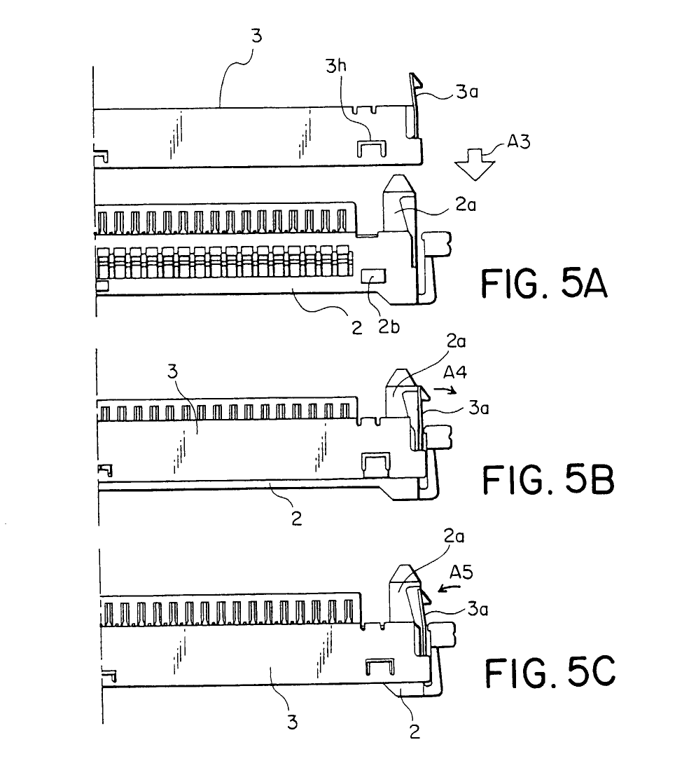

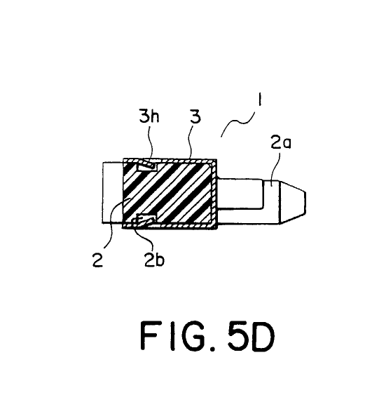

Referring to FIGS. 5A to 5D, the description will be proceeded to an operation of assembling the shielding shell 3 and the housing 2.

The shielding shell 3 is provided with lances 3h formed by cutting in the vicinity of transversal opposite ends of upper and lower surfaces thereof. In correspondence to the lances 3h, the housing 2 is provided with recesses 2b formed in the vicinity of transversal opposite ends of upper and lower surfaces thereof. When the shielding shell 3 is fitted to the housing 2 from the coupling side of the housing 2 in a direction depicted by A3 in FIG. 5A, the state in FIG. 5A proceeds through the state in FIG. 5B to the state shown in FIGS. 5C and 5D. In this state, each lance 3h is engaged with each recess 2b. In the middle of the fitting, each locked arm 3a is brought into contact with each side surface of the housing 2 to be elastically deformed in directions A4 and A5 in FIGS. 5B and 5C.

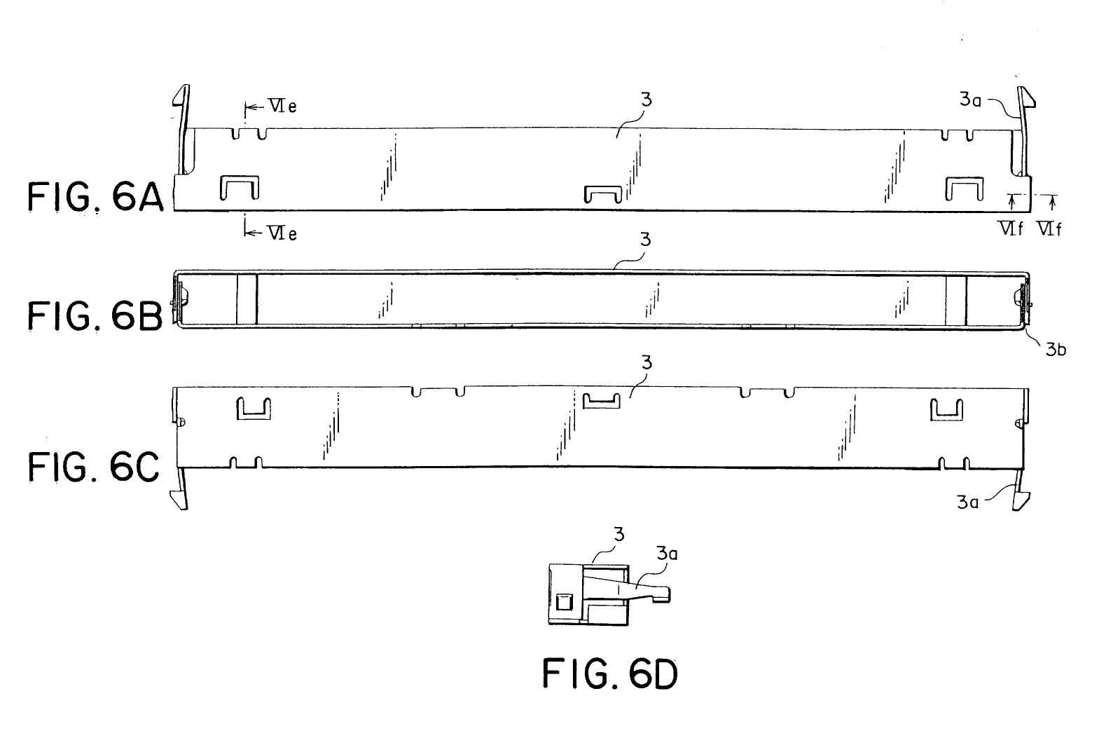

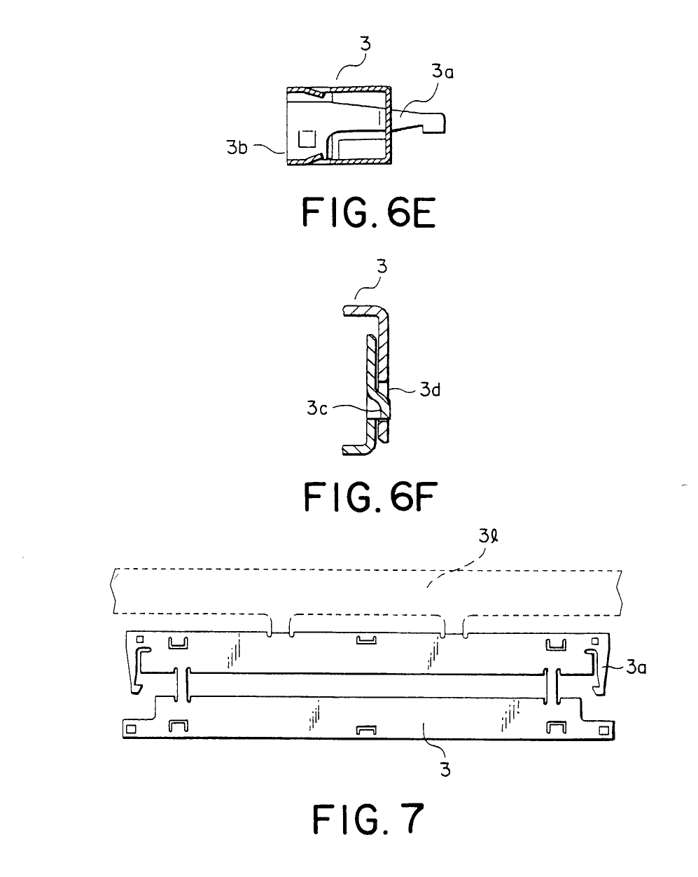

Referring to FIGS. 6A to 6F and 7, the description will be directed to the shielding shell 3 of the cable connector 1.

The shielding shell 3 of the cable connector 1 is shaped by bending so as to cover four surfaces of the cable connector 1 except the coupling side and the cable side. In FIG. 7, the shielding shell 3 is blanked from a metal plate and is not yet separated from a carrier 3l depicted by broken lines. The locked arms 3a are formed at the transversal opposite ends of the shielding shell 3 to be integral therewith and to protrude on the coupling side. In FIG. 6A, each of the locked arms 3a is elastically deformable from its base 3b laterally outwards. Thus, the locked arms 3a can be arranged in a space-saving manner. The shielding shell 3 is provided with protruding bent portions 3c and holes 3d formed on overlapping portions of the opposite side surfaces thereof. By engagement between the protruding bent portions 3c and the holes 3d, the shielding shell 3 is prevented from being opened laterally outwards.

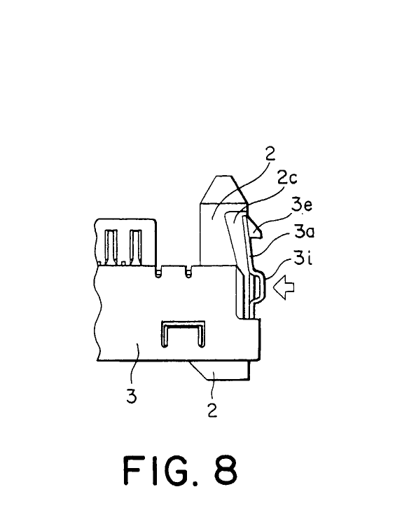

As shown in FIG. 8, the unlocking arm 3f and the finger push portion 3g formed on the housing 2 may be replaced by a direct finger push portion 3i formed by bending the locked arm 3a formed on the shielding shell 3.

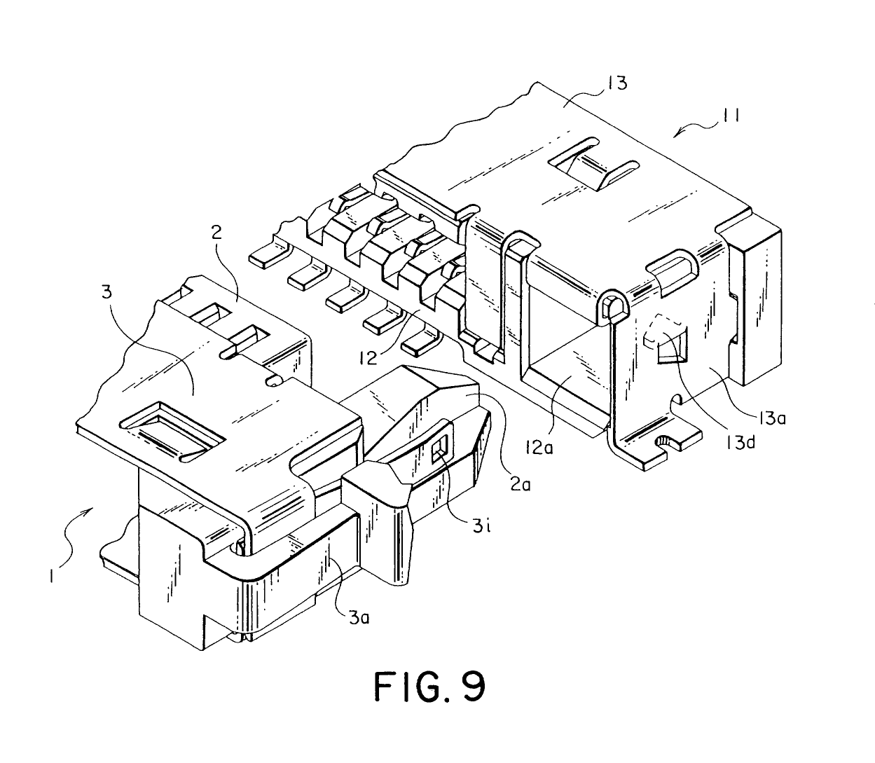

Referring to FIG. 9, description will be made as regards a connector according to another embodiment of the present invention. Similar parts are designated by like reference numerals and will not be described any longer.

In the connector in FIG. 9, the locked arm 3a of the shielding shell 3 is provided with a recess 3j instead of the inclined end 3e in the connector in FIGS. 1 to 4A. In correspondence to the recess 3j, the side surface portion 13a of the shielding shell 13 is provided with a protrusion (locking portion) 13d formed by cutting and raising, instead of the hole 13b in the connector in FIGS. 1 to 4A.

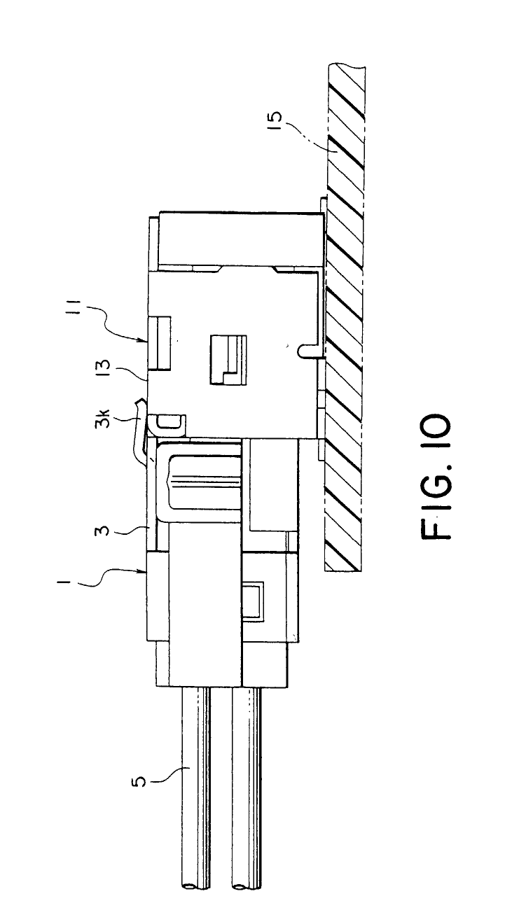

Referring to FIG. 10, description will be made as regards a connector according to a still another embodiment of the present invention.

In the connector in FIG. 10, the shielding shell 3 of the cable connector 1 is provided with a contacting member 3k formed on an upper surface thereof. The contacting member 3k is brought into contact with an upper surface of the shielding shell 13 of the board connector 11 mounted on the board 15 to establish a part of ground connection.

While the present invention has thus far been described in connection with a few embodiments thereof, it will readily be possible for those skilled in the art to put this invention into practice in various other manners. For example, the cable connector 1 is connected to the board connector 11 in parallel thereto in the foregoing description but may be connected to the board connector 11 to be perpendicular thereto. In the foregoing description, the side surface portion 13a of the shielding shell 13 of the board connector 11 is provided with the hole 13b. Instead, the housing 12 may be provided with a hole as an engaging part.

What is claimed is:

1. A connector including first and second connector elements adapted to be connected to and disconnected from each other,
said first connector element comprising:
a first contact;
a first housing holding said first contact;
a first shielding shell covering said first housing;
a first guide portion formed in said first housing; and
a first locking portion coupled to said first shielding shell and faced to said first guide portion,
said second connector element comprising:
a second contact;
a second housing holding said second contact;
a second shielding shell covering said second housing;
a second guide portion integral with said second housing and adapted to be guided by said first guide portion; and
a second locking portion coupled to said second shielding shell, faced to said second guide portion, and adapted to be locked to said first locking portion.

2. The connector according to claim 1, wherein said second locking portion is coupled with said second shielding shell through an elastic arm extending along said second guide portion, said second guide portion having a cut portion allowing said first and said second locking portions to be unlocked with said elastic arm being bent.

3. The connector according to claim 2, wherein said first shielding shell has a side surface portion covering said first guide portion, said cut portion being faced to said side surface portion when said first and said second connector elements are fitted to each other.

4. The connector according to claim 3, wherein said first locking portion is an engaging hole formed in said side surface portion, said second locking portion being an engaging protrusion formed on said elastic arm, said engaging protrusion being engaged with said engaging hole under elastic force of said elastic arm when said first and said second connector elements are fitted to each other.

5. The connector according to claim 3, wherein said first locking portion is an engaging protrusion protruding inward from said side surface portion, said second locking portion being an engaging hole formed in said elastic arm, said engaging hole being engaged with said engaging protrusion under elastic force of said elastic arm when said first and said second connector elements are fitted to each other.

6. The connector according to claim 2, further comprising an operating portion for bending said elastic arm to unlock said first and said second locking portions.

7. The connector according to claim 6, wherein said operating portion has an elastic unlocking arm coupled to said second housing and faced to said elastic arm.

8. The connector according to claim 6, wherein said operating portion is a protrusion formed on said elastic arm.

9. The connector according to claim 1, wherein at least one of said first and said second connector elements has a contacting member for electrically connecting said first and said second shielding shells to each other.

10. The connector according to claim 1, comprising a pair of said first guide portions and a pair of said second guide portions, said first guide portions being asymmetrical with each other, said second guide portions being asymmetrical with each other.

11. A connector having a locking portion for locking a connected state in which said connector is connected to a mating connector,
said connector comprising:
a conductive contact;
an insulator housing holding said contact; and
a conductive shielding shell covering said housing,
said housing having a guide portion for guiding said mating connector when said mating connector is connected, said locking portion being integral with said shielding shell and formed at a position corresponding to said guide portion.

12. The connector according to claim 11, wherein said housing has an additional guide portion for guiding connection with said mating connector in cooperation with said guide portion.

13. The connector according to claim 12, further comprising an additional locking portion integral with said shielding shell and formed at a position corresponding to said additional guide portion, said additional locking portion being for locking a connected state between said connector and said mating connector in cooperation with said locking portion.
